(19) United States
(12) Patent Application Publication
(10) Pub. No.: US 2015/0283747 A1
(43) Pub. Date: Oct. 8, 2015

(54) Spinning Unit of an Air Spinning Machine and a Method for Operating an Air Spinning Machine

(71) Applicant: Maschinenfabrik Rieter AG, Winterthur (CH)

(72) Inventors: Ronald Hofmann, Eschenz (CH); Andreas Fischer, Steckborn (CH)

(21) Appl. No.: 14/677,165

(22) Filed: Apr. 2, 2015

(30) Foreign Application Priority Data
Apr. 3, 2014 (CH) 00522/14

(51) Int. Cl. B29C 47/00

(52) U.S. Cl. CPC B29C 47/0014; B29L 2031/707

(57) ABSTRACT

The invention relates to a spinning unit of an air spinning machine with a spinning nozzle (1), which serves the purpose of producing a yarn (2) from a fiber composite (3) fed to the spinning nozzle (1), whereas the spinning nozzle (1) features an inlet (4) for the fiber composite (3), an internal vortex chamber (5), a yarn formation element (6) protruding into the vortex chamber (5) along with an outlet (7) for the yarn (2) produced inside the vortex chamber (5). In accordance with the invention, it is proposed that the spinning unit is allocated with an additive supply (8), which is designed to supply the spinning unit with an additive (9), whereas the additive supply (8) includes at least one valve (10), with the assistance of which the volume flow and/or mass flow of the additive (9) is adjustable, and whereas the valve (10), during the operation of the same, opens and closes at least once per second, such that the additive (9) fed to the valve (10) leaves the valve (10) in a pulse-like manner. In addition, a method for operating an air spinning machine is proposed.

This invention relates to a spinning unit of an air spinning machine with a spinning nozzle, which serves the purpose of producing a yarn from a fiber composite fed to the spinning nozzle, whereas the spinning nozzle features an inlet for the fiber composite, an internal vortex chamber, a yarn formation element protruding into the vortex chamber along with an outlet for the yarn produced inside the vortex chamber.

Furthermore, a method for the operation of an air spinning machine is proposed, whereas the air spinning machine features at least one spinning unit, whereas the spinning unit features at least one spinning nozzle, whereas, during the operation of the spinning unit, the spinning nozzle feeds a fiber composite through an inlet, and whereas the fiber composite within a vortex chamber of the spinning nozzle receives a twist, such that a yarn is formed from the fiber composite, which ultimately leaves the spinning unit through an outlet. Air spinning machines with corresponding spinning units are known in the state of the art, and serve the purpose of producing a yarn from an elongated fiber composite. Thereby, the outer fibers of the fiber composite are, with the assistance of a vortex air flow generated by the air nozzles within the vortex chamber in the area of an inlet mouth of the yarn formation element, wound around the internal core fibers, and ultimately form the winding fibers that determine the desired strength of the yarn. This creates a yarn with a genuine twist, which may be ultimately led away through a draw-off channel from the vortex chamber, and wound up, for example, on a sleeve.

In general, within the meaning of the invention, the term “yarn” is understood to be a fiber composite, for which at least one part of the fibers is wound around an internal core. Thus, this comprises a yarn in the conventional sense, which may be processed into a fabric, for example with the assistance of a weaving machine. However, the invention also relates to air spinning machines, with the assistance of which so-called “roving” (another name: coarse roving) may be produced. This type of yarn is characterized by the fact that, despite a certain strength, which is sufficient to transport the yarn to a subsequent textile machine, it is still capable of drafting. Thus, the roving may be drafted with the assistance of a drafting device, for example the stretching unit, of a textile machine processing the roving, for example a ring spinning machine, before it is ultimately spun.

In the production of synthetic fibers, such as polyester, or mixtures of natural and synthetic fibers, deposits on the surface of the yarn formation element arise. The production of synthetic fibers comprises a so-called “preparation of continuous fibers” during the production process. Preparation agents, usually oils with various additives, are applied at the continuous fibers; this enables a treatment such as, for example, stretching the continuous fibers at high speeds. Such preparation agents sometimes adhere to the synthetic fibers even during the further treatment, and lead to impurities in the air spinning machine. The fibers fed to the air spinning machine in the form of a fiber composite are typically fed by a pair of delivery rollers of the spinning nozzle. The pair of delivery rollers may match a pair of output rollers of a stretching unit. The stretching unit that is used serves the purpose of the refinement of the advanced fiber composite prior to entering the spinning nozzle.

Typically, a fiber guide element is arranged in the entrance area of the spinning nozzle; through this, the fiber composite is led into the spinning nozzle and finally in the area of the yarn formation element. As yarn formation elements, the majority of spindles are used with an internal draw-off channel. At the top of the yarn formation element, compressed air is introduced through the housing wall of the spinning nozzle in such a manner that the specified rotating vortex air flow arises. As a result, individual external fibers are separated from the fiber composite leaving the fiber guide element and are turned over through the top of the yarn formation element. In the further process, these removed fibers rotate on the surface of the yarn formation element. Following this, through the forward movement of the internal core fibers of the fiber composite, the rotating fibers are wound around the core fibers and thereby form the yarn. However, through the movement of the individual fibers over the surface of the yarn formation element, deposits also form on the yarn formation element because of adhesions on the fibers from the production process. Deposits on the yarn formation element may also be caused by damaged fibers. For the same reasons, deposits may also occur on the surface of the interior of the spinning nozzle or the fiber guide element. These adhesions lead to deterioration of the surface condition of the yarn formation element, and cause a deterioration in the quality of produced yarn. Therefore, the regular cleaning of the affected surfaces is necessary in order to maintain the consistent quality of the spun yarns.

The surfaces of the yarn formation element, the interior of the spinning nozzle and the fiber guide element may be cleaned manually through a periodic disassembly of the yarn formation element, but this leads to a substantial maintenance effort, coupled with a corresponding interruption in operations.

By contrast, EP 2 450 478 discloses a device that enables an automatic cleaning without stopping the machine. For this purpose, an additive is mixed with the compressed air used for the formation of vortex air flow within the spinning nozzle. The additive is guided through the compressed air on the yarn formation element, and results in the cleaning of the surface of the yarn formation element. It is disadvantageous for the disclosed cleaning system that, for the feeding of the additive, an additional compressed air supply of all spinning units of the air spinning machine is necessary and, as a result of this, an elaborate control of the dosage of the additive is to be provided, in order to avoid an overdosage of the additive when individual spinning units are stopped. Moreover, the additive must be fed into a surrounding area with increased surrounding pressure (i.e., the air supply of the spinning nozzle), which places corresponding demands on the dosing device for adjustment to the surrounding pressure that is prevailing at the moment.

JP-2008-095-208 discloses an additional version of the cleaning of the yarn formation element. An additive is also fed to the compressed air used for the swirling in the spinning nozzle, and with such compressed air, is led into the spinning nozzle, and thus to the yarn formation element. In the disclosed version, the dosage and the addition of the additive is separately provided for each spinning unit. Moreover, with this version, the additive must be fed into a surrounding area with increased surrounding pressure, which places corresponding high demands on the dosing device.

In principle, the same problem also occurs if additive is to be fed to the fiber composite, which serves the purpose of improving the properties of the yarn produced from it, with regard to (for example) its hairiness. Corresponding additives may be added to the fiber composite, for example, in the area of the fiber guide element, whereas the dosage should be very precisely adjustable, in order to prevent more than or less than the indicated target additive quantity from being applied to the individual sections of the fiber composite.

Therefore, the task of this invention is to propose a spinning unit of an air spinning machine along with a method for operating an air spinning machine, which enables a supply of one or more spinning units with additive that is particularly consistent and to be adjusted precisely.

The task is solved by a spinning unit and a method with the characteristics of the independent patent claims.

In accordance with the invention, the spinning unit is characterized by the fact that an additive supply is allocated to it, which is designed to supply the spinning unit with an additive. Fluid or even solid substances (or mixtures thereof) may be used as additive, whereas water or an aqueous solution is preferential. The additive reservoir is designed depending on the choice of the additive, and may be formed, for example, by a tank, a distribution system or filled cartridges allocated to the spinning unit. In addition, one or more additive supply lines are provided, through which the additive reservoir is in connection with an additive delivery, whereas the latter may be formed by, for example, a hollow needle, a spray head or an outlet area of a channel section. Through the additive delivery, the additive is ultimately introduced into the spinning nozzle or applied to the fiber composite.

In any case, the additive supply includes at least one valve, with the assistance of which the volume flow and/or mass flow of the additive is adjustable, such that the quantity of the additive introduced on the fiber composite or in the spinning nozzle is controllable, and is thus adjustable on the respective additive or fiber material to be processed.

The core of the invention is that the valve, during the operation of the same, opens and closes at least once per second, such that the additive fed to the valve leaves the valve in a pulse-dike manner. Thus, in contrast to conventional valves, the additive does not continuously flow through the valve in accordance with the invention. Rather, it is provided that the additive stream is composed of a multitude of the smallest droplets or additive units (if a gas or a solid, and not a liquid, is used), which are produced through rapid opening and closing and leave the valve. In doing so, if the valve is opened and closed once or several times per second, an additive stream is produced, which corresponds to a continuous additive stream in its result, even if it actually consists of a multitude of individual droplets that leave the valve closely behind one another. Given that the volume or mass of a droplet or a unit is extremely low, and that the switching frequency of the valve (that is, the number of opening and closing operations per second) is adjustable with a high degree of precision, the quantity of the additive applied to the fiber composite or introduced into the spinning nozzle (in particular, the vortex chamber) is also highly precise and reproducibly adjustable. An additional advantage lies in the fact that if the valve remains in its closed position, it immediately closes completely. If a liquid additive is used, any dripping caused by a low volume of individual droplets is ruled out.

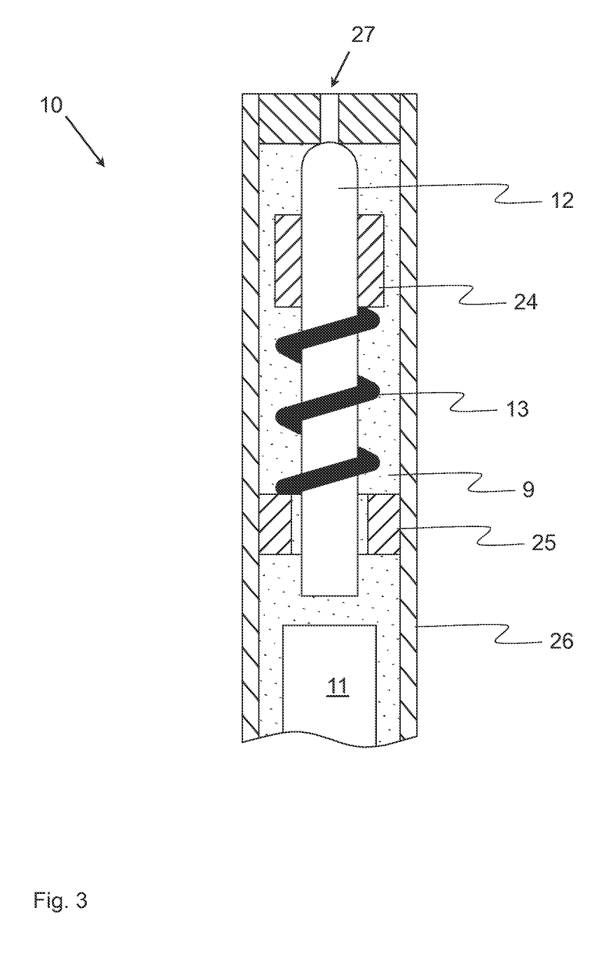

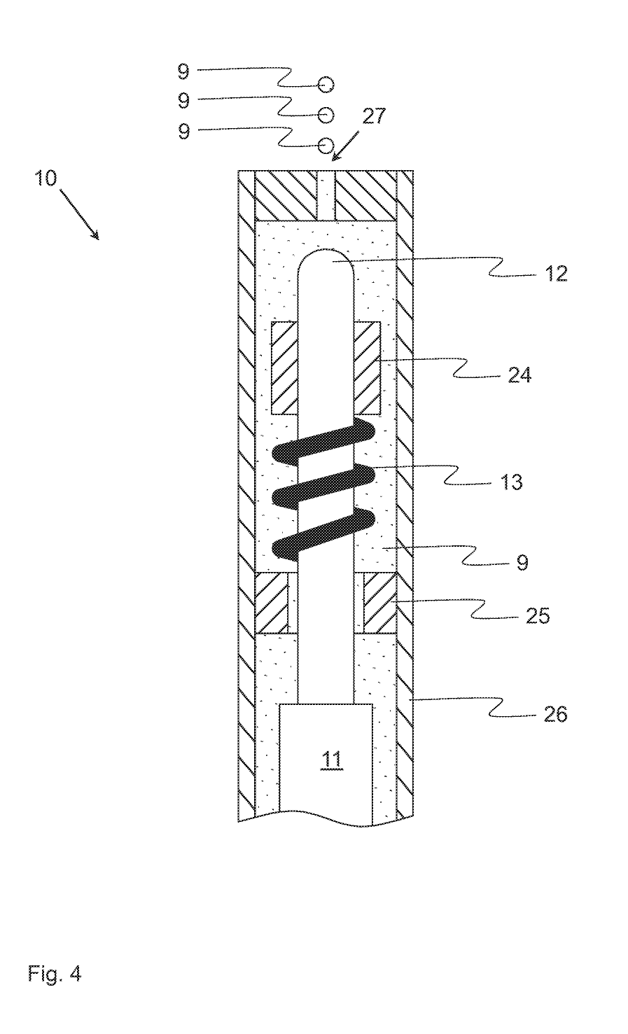

The valve may comprise, for example, a valve that includes an additive opening and a closing element closing such opening in the closed position of the valve. The closing element can be moved back and forth between an open and closed position with the assistance of an electromagnet. Alternatively, it would also be possible that the closing element is held in its closed position (alternatively: in its open position) with the assistance of a mechanical energy accumulator (such as a spring), and moved into its open position (alternatively: into its closed position) with the assistance of the electromagnet. A corresponding valve is more specifically presented in FIGS. 3 and 4, whereas the individual characteristics can be realized within the framework of this invention.

It is advantageous if the frequency, with which the valve is opened and closed again during its operation, features an amount that is a maximum of 100 Hz, preferentially a maximum of 25 Hz, in particular preferentially a maximum of 10 Hz. In particular, depending on the additive that is used or its viscosity along with the pressure acting on the additive in front of the valve, values that are in the single-digit or lower double-digit Hz range are sensible, whereas the frequency during operation of the spinning unit may also vary, in order to adjust the volume flow or mass flow of the additive fed to the spinning unit. For example, it would be sensible to increase the frequency during a cleaning operation, during which the additive serves the purpose of cleaning the spinning nozzle, compared to a frequency that is selected during normal operation, with which the additive primarily serves the purpose of improving the properties of the finished yarn.

It is particularly advantageous if the valve is integrated into an additive supply line of the spinning unit, which connects the at least one additive reservoir to the spinning unit. The additive reservoir contains the additive and may be in connection with, for example, a compressed air source, such that, because of the increased internal pressure of the additive reservoir compared to the pressure prevailing in the vortex chamber, the additive flows into the area of the corresponding spinning nozzle. The additive supply line may run directly between the additive reservoir and the aforementioned additive delivery of the spinning unit, whereas each of the individual spinning units may be allocated with its own additive reservoir. Likewise, several or all spinning units of an air spinning machine may be in fluid connection with a common additive reservoir. In this connection, it is advantageous if the additive reservoir is in connection with a main supply line, from which the individual additive supply lines allocated to the respective spinning units branch off. Thereby, it is conceivable that each additive supply line includes its own valve. It would be likewise possible to equip the main supply line with a corresponding valve.

It is particularly advantageous if the valve is arranged in the area of the spinning nozzle, and/or is fixed to a carrier of the spinning unit. For example, it is conceivable to fix the valve(s) to a frame element of the air spinning machine and connect it to the additive delivery with the assistance of an additive supply line, which is preferably flexible.

It is also advantageous if the air spinning machine includes several spinning units, whereas each spinning unit is allocated with at least one of its own valves. In doing so, the volume flow or mass flow of the additive can be separately adjusted at each spinning unit. Alternatively, it is also conceivable to connect several spinning units to one common valve, whereas, in such a case, several additive supply lines running to the respective spinning nozzles should be in fluid connection with the valve.

It is also advantageous if all valves of the air spinning machine, or individual groups of valves, are in connection with one or more common additive reservoirs. For example, the air spinning machine could include two opposite rows of spinning units, whereas each row could be in connection with a common additive reservoir. Alternatively, all spinning units may of course be in connection with only one additive reservoir, such that the additive reservoir would be centrally placed and easily refillable.

The method in accordance with the invention is characterized by the fact that, during the operation of the air spinning machine, an additive is fed to the spinning unit, at least temporarily, with the assistance of an additive supply, whereas the volume flow and/or mass flow of the additive is adjusted with the assistance of at least one valve, and whereas the valve, during the operation of the same, is opened and closed several times per second, such that the additive fed to the valve leaves the valve in a pulse-like manner. As already stated in the previous description, the pulse-like action of the valve has the advantage that the additive of the spinning unit can be fed in a manner that is highly uniform, finely closed and reproducible. As a result, with an active valve, the additive is continuously fed to the respective additive delivery, even if the additive stream is composed of several of the smallest additive droplets or additive units (if a gas or a solid is used instead of a liquid).

It is advantageous if the additive is applied to the fiber composite and/or is introduced into the spinning nozzle. For example, it is conceivable that the additive is applied outside of the spinning nozzle or in the area of the fiber guide element and is introduced, together with the latter, into the vortex chamber of the spinning nozzle. Depending on the volume flow or mass flow, the additive serves the purpose of either improving the properties of the yarn produced from the fiber composite or cleaning the yarn formation element and/or the vortex chamber, whereas, in such a case, the fiber composite supports the cleaning by means of mechanical contact with the respective surfaces of the yarn formation element. Of course, the additive delivery may also flow directly into the vortex chamber, in order to introduce the additive into it, independent of the fiber composite.

In any event, it is advantageous if a gas and/or a liquid, in particular water or a liquid containing water (such as a cleaning solution), and/or a solid, can be used as the additive. In particular, if, for example, water or liquid containing water is applied in the area of the fiber guide element of the corresponding spinning nozzle or is introduced into the spinning nozzle, the yarn quality is clearly improved with regard to hairiness and strength, elongation and yarn uniformity. Thereby, higher production speeds can be employed, such that the air spinning machine is able to produce more economically and save energy.

It is particularly advantageous if, during its operation, the valve is opened and closed again with a frequency of a maximum of 100 Hz, preferentially with a frequency of a maximum of 25 Hz, in particular preferentially with a frequency of a maximum of 10 Hz. Preferably, the frequency should be selected depending on the properties of the fiber composite fed to the spinning unit and/or the draw-off speed of the yarn thereby produced from it. In particular, the valve described above can thereby be used, with which the movement of the closing element can be effected with the assistance of an electromagnet and, if applicable, a mechanical energy accumulator. The frequency of the corresponding electromagnet (that is, the transfer between the active and passive state) may be selected to be accordingly high, whereas a particularly accurate control of the frequency is possible with a corresponding controller.

It is also advantageous if, during the operation of the valve, the frequency is changed depending on defined guidelines. For example, it is conceivable to increase the frequency during a cleaning operation of the corresponding spinning unit, in order to increase the volume flow or mass flow of the additive. Upon this operation, the additive results in a cleaning in particular of the interior of the vortex chamber or the yarn formation element. For this purpose, the additive is, for example, applied to the fiber composite or injected in the interior of the vortex chamber. A cleaning of the specified areas ultimately takes place through the interaction of the additive with the fiber composite moving in the spinning nozzle, whereas, in such a case, the volume flow or mass flow of the additive should be higher than that during normal spinning operation, since only the fiber composite should be wetted with a small quantity of the additive, in order to have positive effects on the specified yarn properties.

In any event, it is advantageous if the volume flow of the fed additive features, at least temporarily, an amount between 0.01 ml/min und 7.0 ml/min, preferentially between 0.02 ml/min und 5.0 ml/min, in particular preferentially between 0.05 und 3.0 ml/min, and/or if the mass flow of the fed additive features, at least temporarily, an amount between 0.01 g/min und 7.0 g/min, preferentially between 0.02 g/min und 5.0 g/min, in particular preferentially between 0.05 g/min und 3.0 g/min. While higher values allow for a cleaning of the specified areas of the spinning unit, in normal operation, when the additive solely serves the purpose of improving the yarn properties, smaller values are advantageous. As such, the valve should allow for a flow of volume or mass through the specified ranges, in order to operate the individual spinning units in both normal operation and cleaning operation.

In this connection, it is advantageous if the volume flow (or mass flow) of the fed additive, during normal operation of the air spinning machine, features an amount between 0.01 ml/min (or g/min) and 1.5 ml/min (or g/min), preferentially between 0.01 ml/min (or g/min) and 1.0 ml/min (or g/min), and if the volume flow (or mass flow) of the fed additive, during a cleaning operation of the air spinning machine, features an amount between 2.0 ml/min (or g/min) and 7.0 ml/min (or g/min), preferentially between 3.0 ml/min (or g/min) and 7.0 ml/min (or g/min).

The exact value may be selected depending on the characteristics of the fiber composite and/or its feeding speed into the spinning unit and/or the draw-off speed of the yarn from the spinning unit, and thus may vary depending on the application. Likewise, the value may be selected depending on the duration of the cleaning operation or the duration of normal operation between two cleaning stages.

It is particularly advantageous if the control of the volume flow or mass flow of the additive takes place by changing the switching frequency (that is, the number of opening and closing operations per second) of the valve. This is particularly advantageous if a valve that always releases the same quantity of additive upon every opening operation is used, such that the volume flow or mass flow of the additive leaving the valve, with an otherwise constant pressure of the additive, solely depends on the specified frequency. Of course, in addition to or as an alternative to the frequency, the pressure of the additive fed into the valve may also vary. This may be achieved, for example, by modifying the pressure within the additive reservoir providing the additive, or by modifying the pressure generated by a pump delivering the additive, whereas, in such a case, the switching frequency may remain constant. In all other respects, the absolute pressure of the additive in the area of an additive inlet of the valve should be between 1.5 bar and 7 bar. In any case, the specified pressure and frequency should be matched in such a manner that the aforementioned volume flows or mass flows arise.

Additional advantages of the invention are described in the following embodiments. The following is shown:

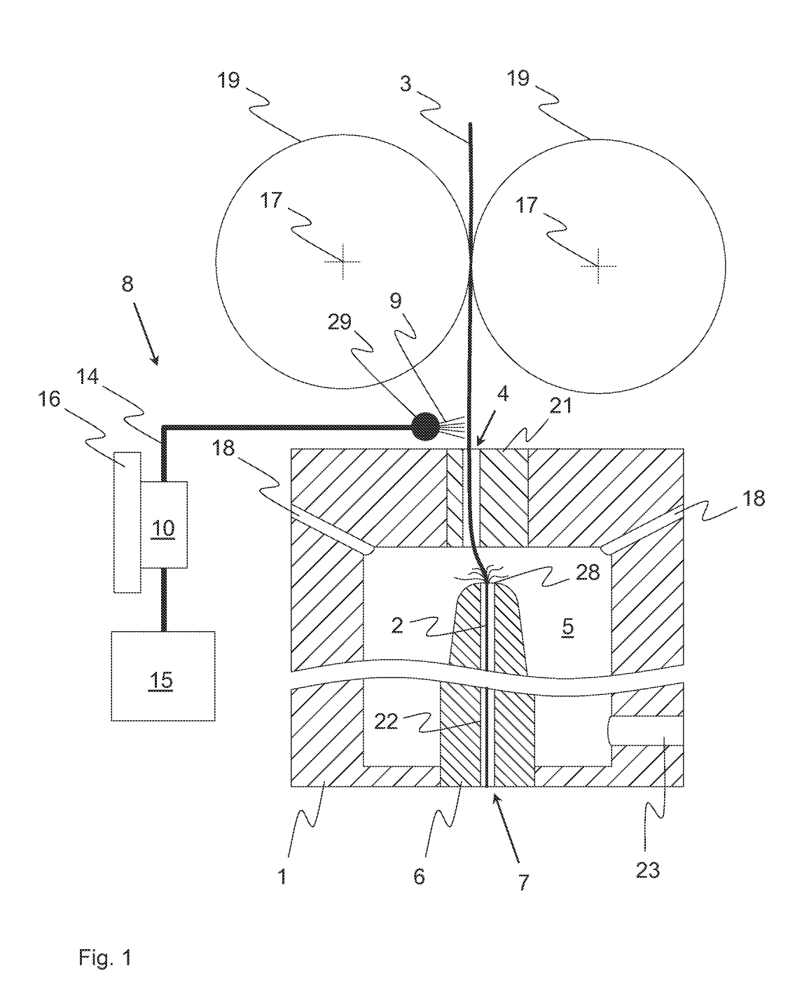

FIG. 1 a cut-out of a spinning unit in accordance with the invention,

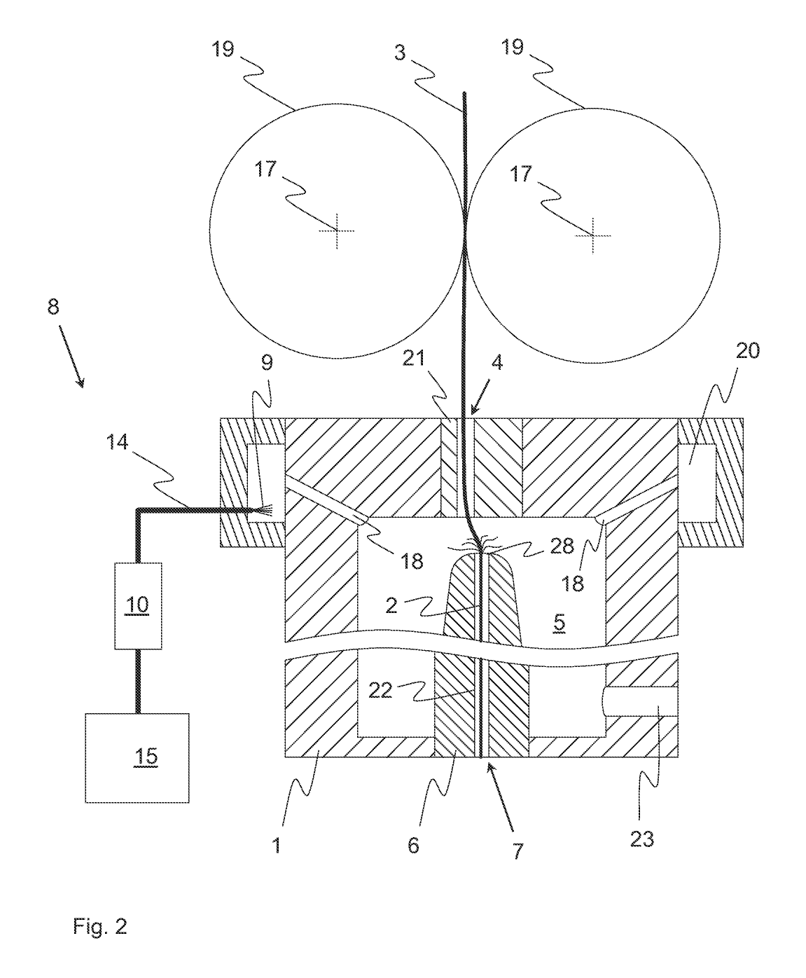

FIG. 2 an alternative version of a spinning unit in accordance with the invention,

FIG. 3 an embodiment of a valve in accordance with the invention in its closed position, and

FIG. 4 the valve shown in FIG. 3 in its open position.

FIG. 1 shows a cut-out of a spinning unit in accordance with the invention of an air spinning machine (whereas the air spinning machine may, of course, feature a multitude of spinning units, preferably arranged in a manner adjacent to each other). When required, the air spinning machine may include a stretching unit, which is supplied with a fiber composite 3 in the form of, for example, a doubled stretching band. Furthermore, the spinning unit of a spinning nozzle 1 with an internal vortex chamber 5, in which the fiber composite 3 or at least a part of the fibers of the fiber composite 3 is, after passing an inlet 4 of the spinning nozzle 1, provided with a twist (the exact mode of action of the spinning unit is described in more detail below).

Moreover, the air spinning machine may include a pair of draw-off rollers (not shown) that is subordinate to the spinning nozzle 1 along with a winding-up device (also not shown) downstream of the pair of draw-off rollers with a sleeve for winding up the yarn 2 leaving the spinning unit. The spinning unit in accordance with the invention need not necessarily feature a stretching unit, whose output side and delivery rollers 19 rotating around an axis of rotation 17 are shown in FIGS. 1 and 2. The pair of draw-off rollers is also not absolutely necessary.

Generally, the spinning unit that is shown works according to an air spinning process. For the formation of the yarn 2, the fiber composite 3 is led through a fiber guide element 21, which is provided with an inlet opening forming the specified inlet 4, into the vortex chamber 5 of the spinning nozzle 1. At that point, it receives a twist; that is, at least a part of the free fiber ends of the fiber composite 3 is captured by a vortex air flow that is generated by air nozzles 18 correspondingly arranged in a vortex chamber wall surrounding the vortex chamber 5. Thereby, a part of the fibers is pulled out of the fiber composite 3 at least to some extent, and wound around the top of the yarn formation element 6 protruding into the vortex chamber 5. Given that the fiber composite 3 is extracted through an inlet mouth 28 of the yarn formation element 6 through a draw-off channel 22 arranged within the yarn formation element 6, out of the vortex chamber 5, and finally through an outlet 7 out of the spinning nozzle 1, the free fiber ends are also ultimately drawn in the direction of the inlet mouth 28 and thereby, as so-called “winding fibers,” loop around the core fiber running in the center—resulting in a yarn 2 featuring the desired twist. The compressed air introduced through the air nozzles 18 leaves the spinning nozzle 1 ultimately through the draw-off channel 22 along with an air outlet channel 23 that might be present, which, when required, may be connected to a vacuum power source.

In general, it must be clarified at this point that the produced yarn generally comprises any fiber composite 3, which is characterized by the fact that an external part of the fibers (so-called “winding fibers”) is looped around an internal part of the fibers that is preferably untwisted or, where required, twisted, in order to impart the desired strength to the yarn 2. The invention also comprises an air spinning machine, with the assistance of which so-called “roving” may be produced. The roving may comprise a yarn 2 with a relatively low proportion of winding fibers, or a yarn 2 for which the winding fibers are looped, relatively loosely, around the inner core, such that the yarn 2 remains capable of drafting. This is crucial if the produced yarn 2 should be or must be drafted on a subsequent textile machine (for example, a ring spinning machine), once again with the assistance of a stretching unit, in order to further process it accordingly.

With regard to the air nozzles 18, it must also be mentioned at this point, purely as a matter of precaution, that they typically should be generally aligned in such a manner that the escaping air streams are unidirectional, in order to generate a unidirectional air flow with a rotational direction. Preferably, the individual air nozzles 18 are thereby arranged in a manner that is rotationally symmetric to each other, and tangentially flow into the vortex chamber 5.

In accordance with the invention, the spinning unit is allocated with an additive supply 8, which includes one or more additive reservoirs 15 along with one or more additive supply lines 14, which are preferably at least partially flexible, through which the respective additive reservoir 15 is in fluid connection with an additive delivery 29 arranged in the area of or within the spinning nozzle 1 (with regard to possible additives 9, reference is made to the prior description).

As a comparison of FIGS. 1 and 2 shows, the additive 9 is delivered at varying locations. While FIG. 1 shows an embodiment with which the additive delivery 29 is located in the area of the inlet 4 of the spinning nozzle 1 (such that the additive 9 may be applied on the fiber composite 3), in the embodiment shown in FIG. 2, the additive 9 may be added to the spinning air. Thereby, the entry of the additive 9 takes place, for example, through an air supply channel 20, which runs, for example, in a ring form around the wall bounding the vortex chamber 5 and through which the air nozzles 18 are supplied with compressed air.

In order to deliver the additive 9 through the additive delivery 29 in a manner that is precise and highly reproducible, and also to adjust the delivered volume flow or mass flow of the additive 9 to the respective circumstances, the additive supply 8 also includes at least one valve 10, which is preferably integrated into the corresponding additive supply line 14, and additive 9 thus flows through it.

The valve 10 is fixed, for example, in the area of the spinning nozzle 1 on a carrier 16 of the air spinning machine (such as a frame section of the same) and is characterized by the fact that, during operation, it is opened and closed at least once per second, such that the additive 9 does not leave the valve 10 as a continuous stream, but in a pulse-like manner in the form of individual units (for example, in the form of individual droplets). In this connection, reference is made to the previous description, in which the advantages of a corresponding valve control are specified.

Alternatively, the valve 10 can of course also be placed directly in the area of the additive delivery 29, or can form this, such that, after leaving the valve 10, the additive 9 does not need to once again be conveyed through a part of the additive supply line 14.

FIGS. 3 (closed position) and 4 (open position) show possible versions of the valve 10 used in accordance with the invention.

In principle, the valve 10 includes a housing 26, which (based on the figures) is supplied with an additive 9 from below, whereas the additive 9 may originate from a pressurized additive reservoir 15 or a line supplied with additive 9 by a pump, which is in fluid connection with the valve 10 through a section of an additive supply line 14.

In addition, the valve 10 includes an additive outlet 27, through which the additive 9 may exit from the valve 10 in the open position (FIG. 4) and may be fed by, for example, an additive supply line 14 (not shown) of the spinning nozzle 1.

In order to close the additive outlet 27, a closing element 12 is also present; with the assistance of a mechanical energy accumulator, for example the spring element 13 that is shown, this is held in the position shown in FIG. 3, and it thereby closes the additive outlet 27. The spring element 13 is preferably arranged between an end stop 25 rigidly fixed to the housing 26 and a contact surface 24 connected to the closing element 12, in order to apply the closing element 12 with a force acting in the direction of the additive outlet 27.

If the electromagnet 11 that is shown is activated, it pulls the closing element 12 against the force generated by the energy accumulator into the position shown in FIG. 4. If the electromagnet 11 is alternately activated and deactivated, the closing element 12 switches between the positions shown in FIGS. 3 and 4, and thereby releases the additive 9 in a pulse-like manner. Depending on the switching frequency of the valve 10 and the pressure of the additive 9 applied at the valve 10, a pulse-like additive stream ultimately arises in a pulse-like manner; the volume flow or mass flow of such stream may be adjusted with a high degree of precision.

The invention is not limited to the illustrated and described embodiments. Variations within the framework of the patent claims, such as any combination of the described characteristics, even if they are illustrated and described in different parts of the description or the claims or in different embodiments.

### LIST OF REFERENCE SIGNS

1. Spinning nozzle
2. Yarn
3. Fiber composite
4. Inlet
5. Vortex chamber
6. Yarn formation element
7. Outlet
8. Additive supply
9. Additive
10. Valve
11. Electromagnet
12. Closing element
13. Spring element
14. Additive supply line
15. Additive reservoir
16. Carrier
17. Axis of rotation
18. Air nozzle
19. Delivery roller
20. Air supply channel
21. Fiber guide element
22. Draw-off channel
23. Air outlet channel
24. Contact surface
25. End stop
26. Housing
27. Additive outlet
28. Inlet mouth
29. Additive delivery

1. Spinning unit of an air spinning machine
with a spinning nozzle (1), which serves the purpose of producing a yarn (2) from a fiber composite (3) fed to the spinning nozzle (1),
whereas the spinning nozzle (1) features an inlet (4) for the fiber composite (3),
an internal vortex chamber (5),
a yarn formation element (6) protruding into the vortex chamber (5) along with
an outlet (7) for the yarn (2) produced inside the vortex chamber (5), characterized in that
the spinning unit is allocated with an additive supply (8), which is designed to supply the spinning unit with an additive (9),
whereas the additive supply (8) includes at least one valve (10), with the assistance of which the volume flow or mass flow of the additive (9) is adjustable, and
whereas the valve (10), during the operation of the same, opens and closes at least once per second, such that the additive (9) fed to the valve (10) leaves the valve (10) in a pulse-like manner.

2-15. (canceled)
